(19) United States
(12) Patent Application Publication
(10) Pub. No.: US 2008/0162850 A1
(43) Pub. Date: Jul. 3, 2008

(54) Three-Dimensional Mask-Programmable Memory Module

(76) Inventor: Guobiao ZHANG, Corvallis, OR (US)

Correspondence Address: GUOBIAO ZHANG, P.O. BOX 6182, STATELINE, NV, 89449-6182, US

(21) Appl. No.: 12/018,178

(22) Filed: Jan. 22, 2008

Related U.S. Application Data
(63) Continuation-in-part of application No. 11/736,757, filed on Apr. 18, 2007.
Application No. 11/736,757 is a continuation-in-part of application No. 11/164,246, filed on Nov. 15, 2005.
Application No. 11/164,246 is a continuation-in-part of application No. 11/036,448, filed on Jan. 15, 2005.
(60) Provisional application No. 60/559,683, filed on Apr. 4, 2004.

(51) Int. Cl. G06F 12/14

(52) U.S. Cl. 711/163; 711/E12.091

(57) ABSTRACT

Three-dimensional mask-programmable memory (3D-mM) module comprises a 3D-mM chip and a usage-control (UC) block. 3D-mM is an ultra-low-cost and ultra-large-capacity memory suitable for pre-recorded multimedia library (PML). The UC block limits access to the PML. It enables a low average selling price (ASP) for the 3D-mM module and allows a user to just pay for the selected usage. The pricing model of the 3D-mM module is more acceptable to consumers.

### CROSS-REFERENCE TO RELATED APPLICATIONS

This application is a continuation-in-part of U.S. patent application Ser. No. 11/736,757, filed Apr. 18, 2007, which is a continuation-in-part of U.S. patent application Ser. No. 11/164,246, filed Nov. 15, 2005, which is a continuation-in-part of U.S. patent application Ser. No. 11/036,448, filed Jan. 15, 2005, which is related to U.S. Provisional Application No. 60/559,683, filed Apr. 4, 2004 and Chinese P.R. patent application No. 200410081241.X, filed Nov. 15, 2004.

### BACKGROUND

1. Technical Field of the Invention

The present invention relates to the field of integrated circuit packaging, and more particularly to the packaging of three-dimensional memory (3D-M).

2. Prior Arts

A three-dimensional memory (3D-M) chip comprises a plurality of vertically stacked memory levels. By using 3D-stacking, 3D-M has an increased storage capacity. However, because 3D-stacking is a very demanding manufacturing process, only one-time- and mask-programmable 3D-M's can be mass-produced in the foreseeable future. As a result, 3D-M is primarily used as a pre-recorded memory, whose contents are recorded before customer delivery.

U.S. Pat. Nos. 5,835,396, 6,034,882, 6,385,074 and others disclose various types of 3D-M. FIG. 1A illustrates a typical 3D-M—one-time-programmable 3D-M (3D-OTP) 10 (referring to Moore, “Matrix Semiconductor White Paper, Matrix 3-D Memory Roadmap Advancements”, May 2005; and U.S. Pat. No. 5,835,396). It comprises four memory levels 10a-10d. Each memory level comprises a plurality of word lines (e.g. 12), bit lines (e.g. 14) and memory cells (e.g. 18). Each memory cell 18 further comprises a diode (not shown in the figure) and an antifuse 16. The antifuse 16 comprises a layer of insulating dielectric, which breaks down during programming. This leads to a high resistance before programming and low resistance after programming. Inter-level dielectric 13 provides electrical separation between memory levels (e.g. 10c, 10d). Memory-level vias (e.g. 10av) provide electrical connection between memory levels (e.g. 10a) and the substrate 11. At present, industry generally believes that, among all 3D-M's, 3D-OTP has the greatest commercial potential. And the only 3D-M product commercially available now is 3D-OTP.

Before shipping, a 3D-M chip is packaged into a 3D-M module. U.S. Pat. No. 6,545,891 discloses such a 3D-M module 20. As illustrated in FIG. 1B, it is housed in a standard memory package (e.g. CF or SD), which can be easily inserted into or pulled out from a mobile device. This 3D-M module 20 comprises a 3D-M chip 26 and an interface chip 28. They are placed side-by-side on a substrate 24. The 3D-M chip 26 uses 3D-OTP (see FIG. 7 of the '891 patent). The interface chip 28 performs a single function, i.e. converts the 3D-M data into a standard format (e.g. CF or SD). It does not limit access to the 3D-M data.

U.S. Pat. No. 6,731,011 discloses another 3D-M module 30. As illustrated in FIG. 1C, it also comprises a 3D-M chip 36 and an interface chip 38. They are vertically stacked on a substrate 34. Similar to FIG. 1B, the 3D-M chip 36 uses 3D-OTP (see FIG. 5 of the '011 patent); and the interface chip 38 does not limit access to the 3D-M data.

The prior-art 3D-M module (20 or 30) prefers 3D-OTP (26 or 36) as its memory chip. However, among all 3D-M's, 3D-OTP has neither the largest storage capacity, nor the lowest storage cost. In fact, three-dimensional mask-programmable memory (3D-mM) excels 3D-OTP in both aspects. More details on the 3D-mM will be disclosed in FIG. 4A.

Besides having a smaller storage capacity and a higher storage cost, the prior-art 3D-M module (20 or 30) faces a more serious hurdle—its pricing model is quite unacceptable to most consumers. For the prior-art 3D-M module (20 or 30), because its interface chip does not limit access to its pre-recorded contents, a customer can access all of its contents once receiving it. This means he/she needs to pay all copyright fees (i.e. copyright fees of all pre-recorded contents) up front during purchase. Thus, the average selling price (ASP) of the prior-art 3D-M module should include not only its hardware cost, but also all copyright fees. As semiconductor technology advances and enables more content storage, this ASP will become very high. For example, by using the storage-enhancing means disclosed in the present invention (e.g. 3D-mM, see FIG. 4A), a 3D-M module can store ˜16 GB, or ˜32 movies at the 50 nm node. This translates to an ASP of $320, a price too high for most consumers. In addition, charging all copyright fees up front is not fair, because consumers may not want to access all contents in a 3D-M module and do not wish to pay for the contents they are not interest in.

In order to overcome these drawbacks, the present invention discloses a three-dimensional mask-programmable-memory (3D-mM) module and system. The 3D-mM module is an ultra-low-cost, ultra-large-capacity memory module, whose pricing model is more acceptable to consumers.

### OBJECTS AND ADVANTAGES

It is a principle object of the present invention to provide an ultra-low-cost, ultra-large-capacity memory module whose pricing model is more acceptable to consumers.

It is another object of the present invention to provide an ultra-low-cost, ultra-large-capacity memory module to store a pre-recorded multimedia library (PML).

It is another object of the present invention to provide an ultra-low-cost, ultra-large-capacity memory module with movie storage cost comparable to DVD.

It is another object of the present invention to provide an ultra-low-cost, ultra-large-capacity memory module, which has a low average selling price (ASP) and allows a user to just pay for the selected usage(s).

In accordance with these and other objects of the present invention, the present invention discloses a 3D-mM module and system.

### SUMMARY OF THE INVENTION

Three-dimensional mask-programmable memory (3D-mM) module comprises a 3D-mM chip and a usage-control (UC) block. Unlike prior arts, the 3D-mM module is not based on 3D-OTP, but based on 3D-mM. Because 3D-mM does not require electrical programming, its structure, design and manufacturing are much simpler than 3D-OTP. At the same technology node, 3D-mM has a storage capacity ˜4 times larger, or a storage cost ˜4 times less than 3D-OTP; and these gaps will become even wider with time. With an ultra-low cost and ultra-large capacity, the 3D-mM module is suitable to store a pre-recorded multimedia library (PML).

The UC block limits access to the pre-recorded contents in the 3D-mM module. This allows a user to just pay for the selected usage(s). Moreover, by distributing the hardware cost into the usage fee(s), the 3D-mM module can be obtained at a nominal average selling price (ASP). This pricing model is more acceptable to consumers. To reduce usage fee(s), advertisements can be played back during content playback.

A 3D-mM system comprises a 3D-mM module and a mobile device. The mobile device plays back the pre-recorded contents stored in the 3D-mM module. To make its pricing model more acceptable to consumers, the 3D-mM system also comprises an UC block. This UC block can be located in the substrate of the 3D-mM chip, in a separate UC chip of the 3D-mM module, or in the mobile device itself.

### BRIEF DESCRIPTION OF THE DRAWINGS

FIG. 1A illustrates a 3D-OTP used in a prior-art 3D-M module; FIG. 1B illustrates a prior-art 3D-M module; FIG. 1C illustrates another prior-art 3D-M module;

FIG. 2A illustrates a preferred 3D-mM system; FIG. 2B is a block diagram of the preferred 3D-mM system;

FIG. 3 is a cross-sectional view of a preferred 3D-mM module;

FIG. 4A is a cross-sectional view of a preferred 3D-mM chip; FIG. 4B (Table 1) compares the storage capacity of 3D-mM, 3D-OTP and flash memories;

FIG. 5 illustrates a preferred distribution model for the preferred 3D-mM system;

FIGS. 6A-6B illustrate two preferred access methods;

FIGS. 7A-7B illustrate another preferred 3D-mM module and its integrated 3D-mM chip;

FIGS. 8A-8B illustrate another preferred 3D-mM system and its encrypted 3D-mM module;

FIGS. 9A-9B are block diagrams of two preferred UC blocks;

FIGS. 10A-10B illustrate a preferred 3D-mM system with advertisements and a preferred distribution model thereof.

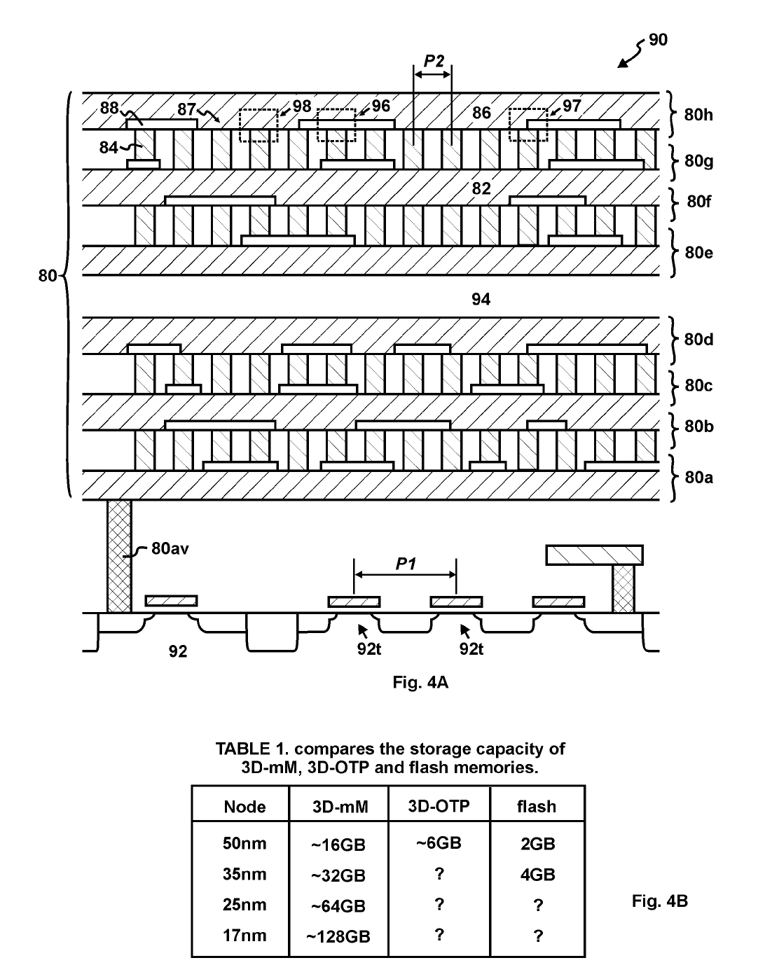

For reason of simplicity, the diode(s) in the 3D-mM cells of FIG. 4A is not shown. In FIG. 4B (Table 1), “?” means it is unlikely to scale the memory to this technology node.

### DETAILED DESCRIPTION OF THE PREFERRED EMBODIMENTS

Those of ordinary skills in the art will realize that the following description of the present invention is illustrative only and is not intended to be in any way limiting. Other embodiments of the invention will readily suggest themselves to such skilled persons from an examination of the within disclosure.

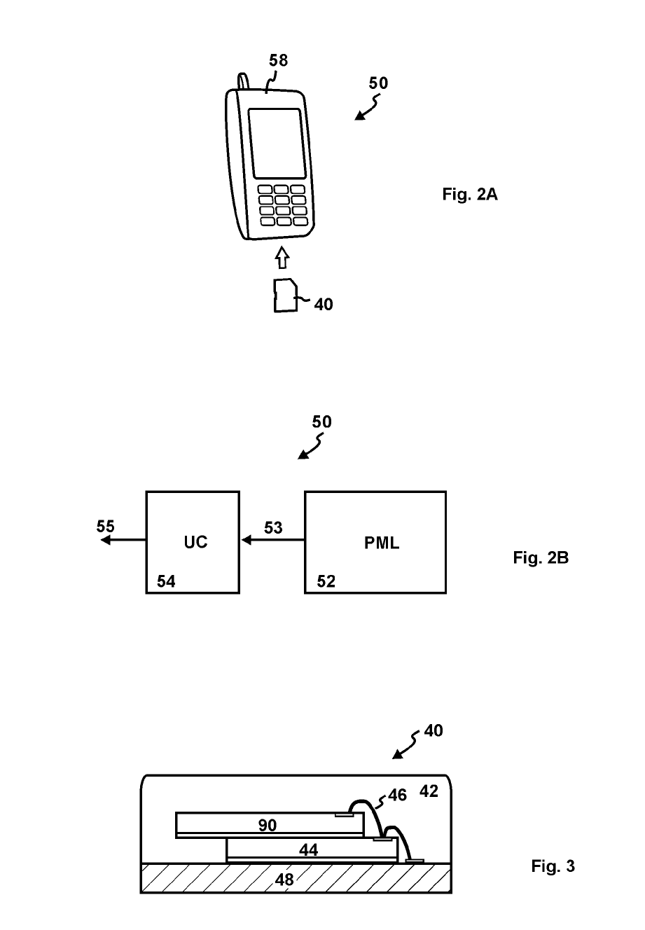

Referring now to FIG. 2A, a preferred 3D-mM system 50 is illustrated. It comprises a mobile device 58 and a 3D-mM module 40. The mobile device 58 plays back the pre-recorded contents stored in the 3D-mM module 40. It could be a cellular phone, a mobile audio player (e.g. mp3 player), a mobile video player (e.g. mp4 player), a mobile game machine, a GPS device, a portable computer and others. The 3D-mM module 40 stores the pre-recorded contents to be played by the mobile device 58. It can be inserted into and pulled out from the mobile device 58; or, it can be embedded into the mobile device 58. It should be apparent to those skilled in the arts that, besides being used on the go, the 3D-mM module 40 can also be used at home or in office.

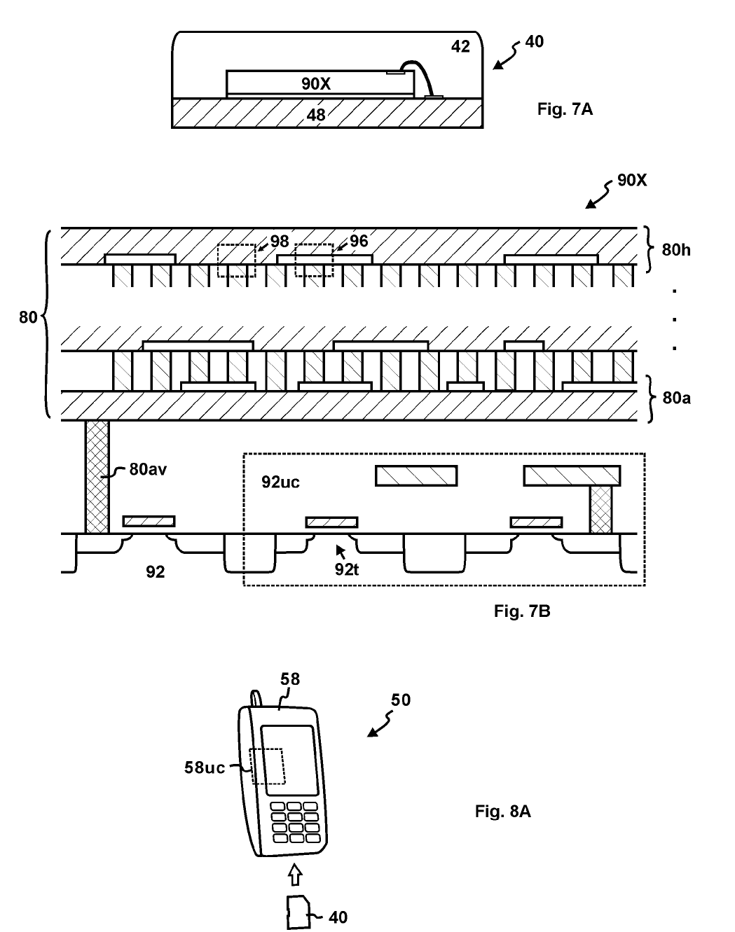

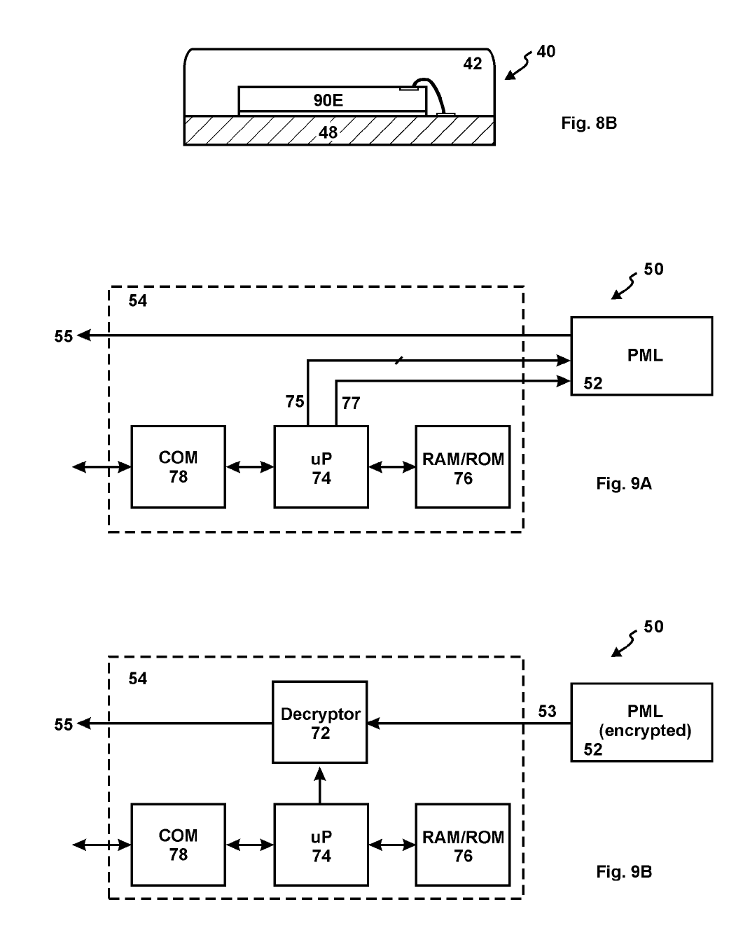

Referring now to FIG. 2B, a block diagram of the preferred 3D-mM system 50 is disclosed. It comprises two functional blocks: a pre-recorded multimedia library (PML) 52 and a usage-control (UC) block 54. The PML 52 is stored in the 3D-mM module 40. It contains a large amount of textual, audio, image, video, game, and/or software contents. The UC block 54 limits access to the PML 52 and allows a user to just pay for the selected usage(s). During usage, the PML readout 53 is fed into the UC block 54, which decides whether the user has the rights to access. If affirmative, the PML readout 53 is further sent to the 3D-mM output 55. It should be noted that the UC block 54 can be located in the substrate 92 of the 3D-mM chip 90X (FIG. 7B), in a separate UC chip 44 of the 3D-mM module 40 (FIG. 3), or in the mobile device 58 (FIG. 8A).

Referring now to FIG. 3, a cross-sectional view of a preferred 3D-mM module 40 is disclosed. It comprises a 3D-mM chip 90 and a UC chip 44. The 3D-mM chip 90 stores the PML 52 and is stacked on the UC chip 44. The UC chip 44 comprises the UC block 54 and is stacked on a substrate 48. Both chips 90, 44 are preferably encapsulated in a protective package 42, such as in a molding compound. During usage, the PML readout from the 3D-mM chip 90 is fed into the UC chip 44 through bond wire 46; then the UC chip 44 decides whether to send the PML readout to the 3D-mM output. Because the bond wire 46 is located inside the protective package 42 and the PML readout is never exposed to the external world, the PML 52 stored in the 3D-mM chip 90 could be plaintext. In this preferred embodiment, the 3D-mM chip 90 is stacked on the UC chip 44. Alternatively, the 3D-mM chip 90 can be located below the UC chip 44; or, they can be placed side-by-side.

Referring now to FIG. 4A, a preferred 3D-mM chip 90 is illustrated. It comprises eight memory levels 80a-80h. They form a 3D-mM stack 80. Each memory level (e.g. 80h) comprises a plurality of word lines (e.g. 84), bit lines (e.g. 86) and 3D-mM cells (e.g. 96-98). It is coupled with the substrate 92 through a plurality of memory-level vias (e.g. 80av). In this preferred embodiment, the 3D-mM cells 96 and 98 store logic “0” and “1”, respectively. They have different structures: at the 3D-mM cell 96, an info-dielectric 88 separates the word line from the bit line; while at the 3D-mM cell 98, the word line is connected with the bit line through an opening 87 in the info-dielectric 88. Here, 3D-mM cell 98 further comprises a diode (not shown). Its electrical resistance is higher when the current flows in one direction than the other.

Because 3D-mM does not require electrical-programming, its structure, design and manufacturing are much simpler than 3D-OTP. For example, 3D-mM can use a simpler peripheral circuit than 3D-OTP and therefore, has a better array efficiency (i.e. the ratio of the total cell area and the total chip area). To further increase its storage capacity, 3D-mM can use advanced techniques such as N-ary 3D-mM, hybrid-level 3D-mM and small-pitch 3D-mM.

In an N-ary 3D-mM, the 3D-mM cell can have N(N>2) possible states. Besides the logic “0” and “1” states, 3D-mM 90 has a third state—the 3D-mM cell 97, where the info-dielectric 88 does not completely isolate the word line from the bit line. The N-ary 3D-mM 90 supports multi-bit-per-cell. In contrast, because it is difficult to control the antifuse's post-programming resistance, 3D-OTP 10 only supports single-bit-per-cell. More details on the N-ary 3D-mM are disclosed in U.S. patent application Ser. No. 11/162,262, “N-ary Mask-Programmable Memory”, filed Sep. 2, 2005.

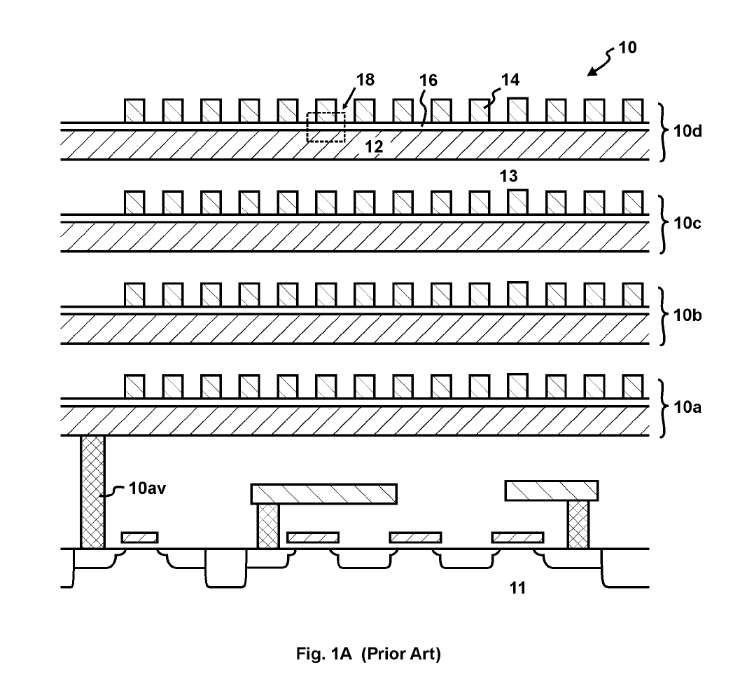

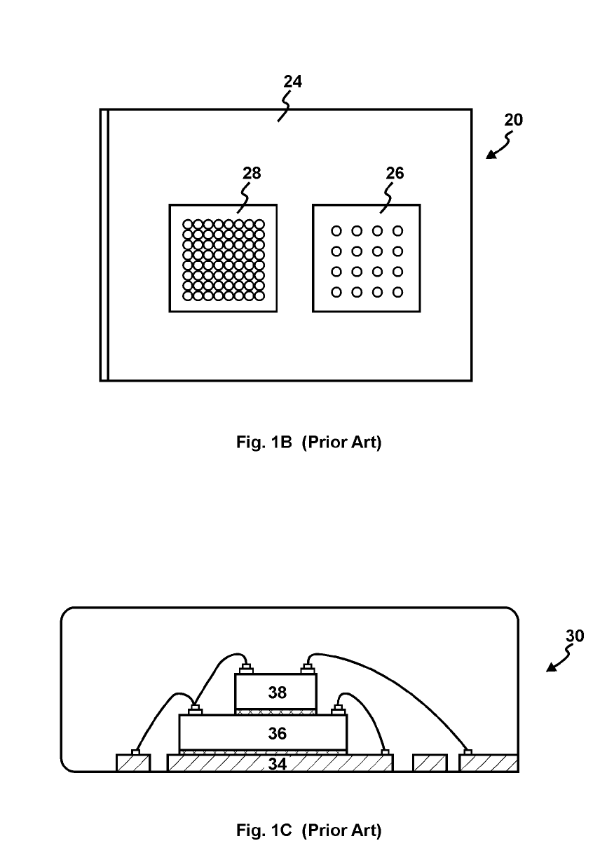

In a hybrid-level 3D-mM, some memory levels (e.g. 80e, 80d) are separated by an inter-level dielectric 94, while other memory levels (80a-80s, 80e-80h) are interleaved, i.e. adjacent memory levels (e.g. 80g, 80h) share one level of address-selection lines (e.g. 84). In contrast, to avoid inadvertent programming between memory levels, all memory levels (10a-10d) in the 3D-OTP 10 are separated by an inter-level dielectric 13 (FIG. 1A). By interleaving memory levels, 3D-mM can significantly improve its storage capacity. More details on the hybrid-level 3D-mM are disclosed in U.S. patent application Ser. No. 11/736,767, “Hybrid-Level Three-Dimensional Memory”, filed Apr. 18, 2007.

In a small-pitch 3D-mM, the minimum pitch (P2) of address-selection lines (e.g. 84) in a 3D-mM level (e.g. 80h) is smaller than the minimum gate pitch (P1) of the substrate transistors 92t. Here, pitch is the center-to-center distance between adjacent lines. The small-pitch 3D-mM becomes possible because the 3D-mM cells (e.g. 96-98) are based on diode and diode follows a different scaling rule than transistor. Furthermore, because the 3D-mM cells (e.g. 96-98) comprise no antifuse and do not need to tolerate a large programming current, 3D-mM can scale to the more advanced technology nodes than 3D-OTP. More details on the small-pitch 3D-mM are disclosed in U.S. patent application Ser. No. 11/936,069, “Small-Pitch Three-Dimensional Mask-Programmable Memory”, filed Nov. 6, 2007.

Combining the above techniques, 3D-mM becomes an ultra-low-cost and ultra-large-capacity memory. FIG. 4B (Table 1) compares the storage capacity of 3D-mM, 3D-OTP and flash memories. At the same technology node, 3D-mM has a storage capacity ˜4 times larger, or a storage cost ˜4 times less than 3D-OTP; and these gaps will become even wider with time. At the 50 nm node, a 3D-mM chip can store ˜16 GB, or ˜32 movies. Its movie storage cost (i.e. average storage cost per movie) is ˜0.4. This is comparable to DVD, whose movie storage cost is ˜0.2-$0.7. Furthermore, 3D-OTP will unlikely scale beyond 50 nm, while 3D-mM can scale down to 17 nm. At the 17 nm node, a 3D-mM chip can store ˜128 GB and its movie storage cost could be as low as ˜0.05.

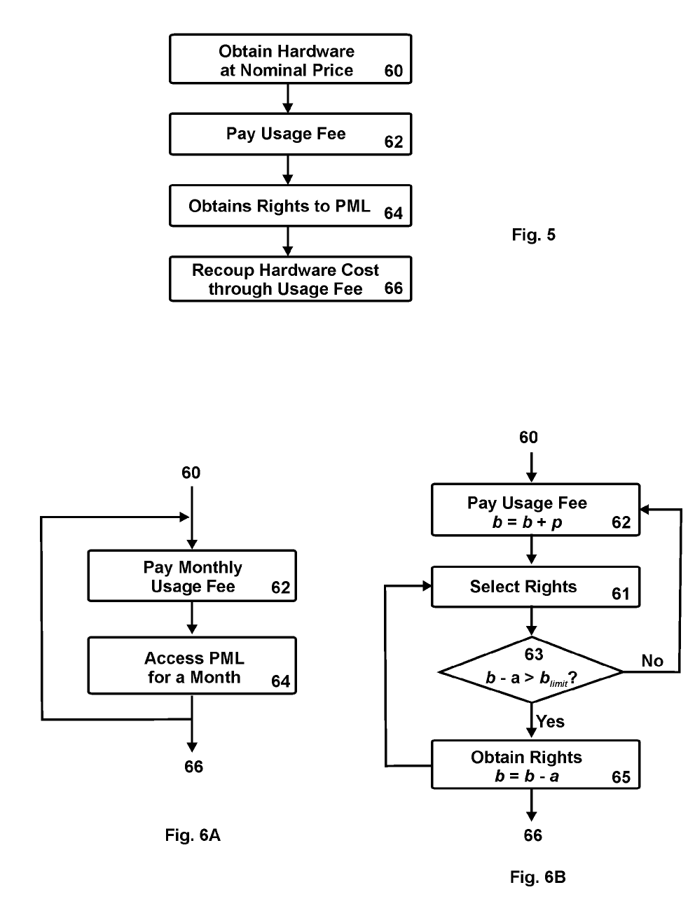

Referring now to FIG. 5, a preferred distribution model for the preferred 3D-mM system 50 is illustrated. A user first obtains the hardware (e.g. the 3D-mM module 40) (step 60). After paying a usage fee (step 62), the user obtains the desired rights (step 64). Here, payment can be made before usage (like a pre-paid phone card), or after usage (like a credit card). Because the usage fee could include not only the copyright fee, but also a portion of the hardware cost, the hardware manufacturer(s) could recoup the hardware cost through the usage fees (step 66). Accordingly, during purchase, the user could just pay a nominal average selling price (ASP) for the hardware (e.g. the 3D-mM module 40, and/or the mobile device 58), or even get the hardware for free (step 60). This can lower the market entry barrier for the 3D-mM system 50.

Referring now to FIGS. 6A-6B, two preferred access methods for the preferred 3D-mM system 50 are illustrated. In the first preferred access method of FIG. 6A, a user pays a monthly usage fee (step 62), then accesses the PML 52 for a month (step 64). For example, after paying a monthly full-access fee (e.g. $50), a user can watch all movies in the PML 52 within one month; after paying a monthly partial-access fee (e.g. $20), a user can watch 10 movies from the PML 52 within one month.

In the second preferred access method of FIG. 6B, the 3D-mM system 50 keeps record of an account balance (b). This account balance tracks the payment and usage history. After the user makes a payment (p), the account balance is credited, i.e. b=b+p (step 62). During usage, the user selects the desired rights (step 61), which require a usage fee (a). As long as the remaining balance (=b−a) is above a threshold bₗᵢₘᵢₜ (step 63), the user can obtain the selected rights and the corresponding usage fee is deducted from the account balance, i.e. b=b−a (step 65).

FIG. 7A illustrates another preferred 3D-mM module 40. It comprises an integrated 3D-mM chip 90X. This integrated 3D-mM chip 90X integrates the UC block 54 with the 3D-mM stack 80. FIG. 7B discloses more details on the integrated 3D-mM chip 90X. Because the 3D-mM cells (e.g. 96-98) do not occupy any substrate area, transistors 92t in the substrate 92 could be used to form an UC circuit 92uc, which performs the function of the UC block 54. During usage, the PML readout from the 3D-mM stack 80 is directly fed into the UC circuit 92uc. Because the PML readout is located inside the integrated 3D-mM chip 90× and never exposed to the external world, the PML 52 stored in the 3D-mM stack 80 could be plaintext.

FIG. 8A illustrates another preferred 3D-mM system 50. It also comprises a 3D-mM module 40 and a mobile device 58. Unlike the preferred embodiments in FIGS. 3 and 7A-7B, the UC block 54 is realized in this preferred embodiment by an UC circuit 58uc, which is located in the mobile device 58. One benefit of this design is that the UC circuit 58uc can share resources (e.g. uP, RAM, ROM) with the mobile device 58. On the other hand, the 3D-mM module 40 does not comprise the UC block, and its 3D-mM chip is an encrypted 3D-mM chip 90E. In the encrypted 3D-mM chip 90E, at least a portion of its contents are encrypted. Thus, the copyright of the PML 52 is still preserved, even though the PML readout from the 3D-mM module 40 is exposed to the external world. It should be apparent to those skilled in the art that the PML 52 stored in the 3D-mM modules of FIGS. 3 and 7A-7B could also be encrypted. This can further enhance the copyright protection of these 3D-mM modules.

Referring now to FIG. 9A, the block diagram of a first preferred UC block 54 is disclosed. It comprises a micro-processor (uP) 74, memory (including RAM and ROM) 76, and communication means (COM) 78. The ROM 76 stores information such as device ID, account balance, usage fees and encryption keys. The uP 74 determines whether a user has the rights to access. If affirmative, a read-enable signal 77, together with the content-address 75, is sent to the 3D-mM that stores the PML 52. With the read-enable signal 77 asserted, the selected contents from the PML 52 are sent to the 3D-mM output 55. This preferred embodiment can be applied to the 3D-mM modules which store the plaintext PML (e.g. FIGS. 3 and 7A-7B).

Referring now to FIG. 9B, the block diagram of a second preferred UC block 54 is disclosed. Compared with FIG. 9A, at least a portion of its PML 52 is encrypted and it further comprises a decryptor 72. The decryptor 72 can decrypt the encrypted PML 52 with an encryption key. When the uP 74 determines a user has the rights to access, the corresponding encryption key will be sent to the decryptor 72. This preferred embodiment can be applied to the 3D-mM modules which store the encrypted PML (e.g. FIGS. 3, 7A-7B and 8B).

In FIGS. 9A-9B, through the COM 78, the 3D-mM system 50 intermittently communicates with an authorization center. For example, during the payment process (step 62), a user first makes the payment (p) to the authorization center; then the authorization center sends back a code to credit the account balance (b). The COM 78 could be telephone (landline or cellular), internet (wired or wireless), or other means. Cellular phone is particularly convenient because cellular signals have the widest coverage and payment can be directly deducted from the user's cellular account.

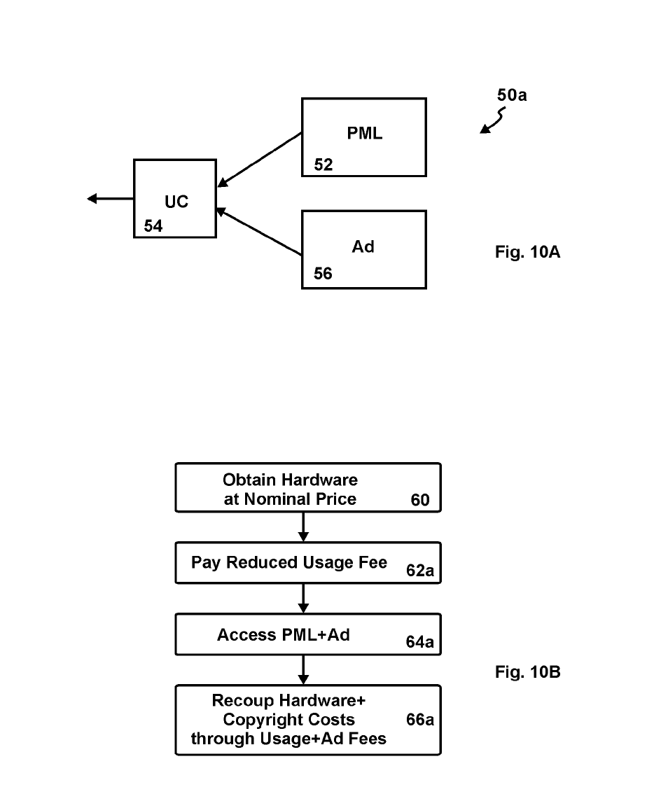

Referring now to FIG. 10A, a preferred 3D-mM system with advertisements 50a is illustrated. Besides the PML 52, it further contains advertisements 56. The UC block 54 controls which advertisement(s) to play and when. A user will be charged a reduced usage fee if advertisement playback is accepted during content playback.

Referring now to FIG. 10B, a preferred distribution model for this 3D-mM system 50a is disclosed. During content playback, if advertisement playback is accepted (step 64a), a user pays a reduced usage fee (step 62a). The hardware and copyright costs are recouped through both the usage and advertisement fees (step 66a). In an extreme case when enough advertisements are played back, a user could get the hardware for free, or even access the multimedia contents for free.

While illustrative embodiments have been shown and described, it would be apparent to those skilled in the art that may more modifications than that have been mentioned above are possible without departing from the inventive concepts set forth therein. For example, the 3D-mM module disclosed in the present invention comprises a single 3D-mM chip. In fact, it can comprise more than one 3D-mM chip, or even other chips. The invention, therefore, is not to be limited except in the spirit of the appended claims.

What is claimed is:

1. A three-dimensional mask-programmable memory (3D-mM) module, comprising:
a 3D-mM chip, wherein said 3D-mM chip comprises a plurality of vertically stacked 3D-mM memory levels and stores a pre-recorded multimedia library (PML); and
a usage-control block for controlling the usage of said PML.

2. The 3D-mM module according to claim 1, wherein at least a portion of the contents in said PML are encrypted.

3. The 3D-mM module according to claim 1, wherein at least a portion of the contents in said PML are plaintext.

4. The 3D-mM module according to claim 1, wherein said PML contains textual, audio, image, video, game, and/or software contents.

5. The 3D-mM module according to claim 1, wherein the movie storage cost of said 3D-mM module is comparable to DVD.

6. The 3D-mM module according to claim 1, wherein said 3D-mM chip is an N-ary 3D-mM (N>2).

7. The 3D-mM module according to claim 1, wherein said 3D-mM chip is a hybrid-level 3D-mM.

8. The 3D-mM module according to claim 1, wherein said 3D-mM chip is a small-pitch 3D-mM.

9. The 3D-mM module according to claim 1, wherein said usage-control block is located in a usage-control chip of said 3D-mM module.

10. The 3D-mM module according to claim 1, wherein said usage-control block is located in said 3D-mM chip.

11. The 3D-mM module according to claim 1, whereby a user pays a nominal average selling price (ASP) for said 3D-mM module and a usage fee for the selected usage.

12. A three-dimensional mask-programmable memory (3D-mM) system, comprising:
a 3D-mM chip, wherein said 3D-mM chip comprises a plurality of vertically stacked 3D-mM memory levels and stores a pre-recorded multimedia library (PML); and
a usage-control block for controlling the usage of said PML.

13. The 3D-mM system according to claim 12, wherein at least a portion of the contents in said PML are encrypted.

14. The 3D-mM system according to claim 12, wherein said PML contains textual, audio, image, video, game, and/or software contents.

15. The 3D-mM system according to claim 12, further comprising a mobile device, wherein said mobile device plays back selected contents in said PML.

16. The 3D-mM system according to claim 15, wherein said mobile device is a cellular phone, a mobile audio player, a mobile video player, a mobile game machine, a GPS device, or a portable computer.

17. The 3D-mM system according to claim 12, wherein said usage-control block is located in said mobile device and said 3D-mM chip is located in a 3D-mM module.

18. The 3D-mM system according to claim 12, wherein said 3D-mM chip and said usage-control block are located in a 3D-mM module.

19. The 3D-mM system according to claim 12, whereby a user pays a nominal average selling price (ASP) for said 3D-mM system and a usage fee for the selected usage.

20. The 3D-mM system according to claim 12, further containing advertisements, whereby a user pays a reduced usage fee when advertisement playback is allowed during content playback.
